(19) United States
(12) Patent Application Publication
(10) Pub. No.: US 2006/0097044 A1
(43) Pub. Date: May 11, 2006

(54) Personalized grocery shopping selection list method and system

(76) Inventors: Terry L. Boyd, Indianapolis, IN (US); Phyllis J. Boyd, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 10/986,982

(22) Filed: Nov. 11, 2004

(51) Int. Cl. G06K 15/00

(52) U.S. Cl. 235/383

(57) ABSTRACT

The present invention provides a method and system for use by a consumer to enhance the consumer's shopping experience at a retail store previously visited by the consumer. The present invention provides a method of creating a personalized shopping list for the consumer, the method including the steps of obtaining a consumer's list items; obtaining item location information; and using the list items and the item information to create a shopping list containing the list items and the location within the retail store of store items one of the same as and similar to the list items.

### TECHNICAL BACKGROUND

The invention generally relates to a retail store shopping aid and, more specifically, to a method and system including a user device to enhance the retail store shopping experience.

### BACKGROUND OF THE INVENTION

Various electronic and/or computerized shopping aids and systems have been developed to assist a shopper with the often burdensome task of shopping at retail stores, particularly grocery stores. One example of a computerized shopping aid includes computer software that provides an aisle-by-aisle grocery shopping list for a shopper after the shopper has input customized local store information (i.e., the layout of the store's aisles and the order in which the shopper prefers to walk aisles).

Loyalty, or value, cards are cards that are typically issued by retail stores to “loyal” or frequent shoppers. The cards are then used by the recipient shoppers to earn rewards or discounts at the retail and/or related stores that issued the cards. In this regard, retail store loyalty cards have been known in the art and are currently being used today to reward customers for shopping at the card-issuing store.

### SUMMARY OF THE INVENTION

While electronic and computerized shopping aids are not novel, there is need in the art to use loyalty card technology to help create a customized shopping list for a retail store customer based on the customer's past shopping experiences. The present invention, therefore, enhances a customer's shopping experience by using loyalty card technology in generating a shopping list for the customer.

In one form, the present invention provides a method of creating the shopping list, the method including the steps of obtaining a shopper's list items, the list items identifying items that the customer has purchased from a retail store; obtaining item location information, the item location information identifying the location of store items within the retail store; and using the list items and the item information to create a shopping list containing the list items and the location within the retail store of store items one of the same as and similar to the list items.

In another form of the present invention, a system includes a processor and a software module containing instructions executable by the processor to create a shopping list, the shopping list including both list items and the location within the retail store of store products one of the same as and similar to the list items.

In still another form, the present invention provides a machine-readable program storage device for encoding instructions for a method of creating the shopping list, the method including the steps of obtaining the shopper's list items; obtaining item location information; and creating a shopping list including the list items and the location within the retail store of store items one of the same as and similar to the list items.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a simplified flow diagram illustrating the basic method steps implemented by the present invention;

FIG. 2 is a block diagram generally illustrating how a personalized shopping list is created in accordance with the present invention;

FIG. 3A is an illustrative example of item location information;

FIG. 3B is an illustrative example of list item information;

FIG. 3C is an illustrative example of a personalized shopping list;

FIG. 4 is a schematic drawing generally illustrating one example of a computer network environment in which the method and system of the present invention may be used; and

FIG. 5 is the flow diagram of FIG. 1 illustrating the basic method steps implemented by the present invention that includes a shopper-criteria request steps.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and system for operating a computer in processing electrical or other (e.g., mechanical, chemical) physical signals to generate other desired physical signals.

The present invention also relates to a system for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Object-oriented programming makes simulation of systems of interrelated components more intuitive. Most of the sequence of operations carried out by a computer in response to an object-oriented program are “invisible” to an observer since only a relatively few steps in the program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network” or “WAN” mean two or more computers which are connected in such a manner that messages may be transmitted between the computers. A world wide network of computers is commonly referred to as the “Internet.” In computer networks such as those described herein, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The use of the term “retail store” hereinafter refers to a store in which any variety of consumer goods may be purchased, e.g., a grocery store, a convenience market, a one-stop shopping store and/or a clothing store. The use of the term “list item” hereinafter refers to any retail store consumer good that a customer has previously purchased from a retail store. The use of the term “item location information” refers to any data used by a retail store to identify where in the store the consumer goods are located. For example, item location information could include a particular section (e.g., produce, dairy, etc.), row, aisle or shelf of the retail store. The item location information also includes data indicative of reasonable substitutes for each consumer good. For example, item location information indicates that both Brand X yellow mustard and Brand Y yellow mustard are on shelf A1 in aisle A.

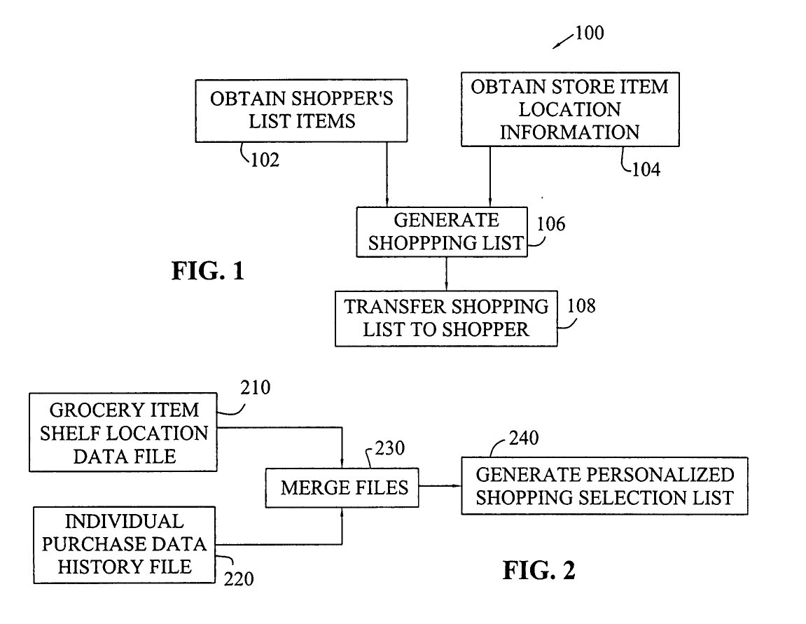

Flow chart 100 of FIG. 1 illustrates the general steps followed to generate a personalized grocery shopping list for a shopper. At step 102, the shopper's list items are obtained. Because the shopper's list items are simply data representative of those items which the shopper has previously purchased from a particular retail store, the list items may be stored on the retail store's server, in memory on a retail store computer, in memory on the shopper's home computer, as a hardcopy (e.g., a receipt) in the shopper's files or as a hardcopy in the retail store's files.

The item location information is obtained at step 104, and similar to the list items, the item location information may be maintained as inventory information on the retail store's server, on a retail store computer, or in hardcopy form in the retail store's files. Upon obtaining the list items and item location information at steps 102 and 104, a personalized shopping list is generated at step 106 that includes both the list items and the location of those list items within the retail store. Because it is possible that the items previously purchased by the shopper are either no longer sold by the retail store or out of stock, the generated shopping list includes the location of a reasonable alternative to the “missing” item. In keeping with the above-example, if the shopper's list item included Brand X yellow mustard as a list item that had been previously purchased by the shopper, the shopping list generated at step 106 would include Brand Y yellow mustard if Brand X was not available (and, hence, not obtained at step 104).

After the personalized shopping list is created at step 106, the shopping list is transferred to the shopper at step 108 to enhance the shopper's next trip to the retail store. The shopping list may be printed out at the retail store and given to the shopper at the cash register, mailed to the shopper, or electronically delivered to the shopper via e-mail.

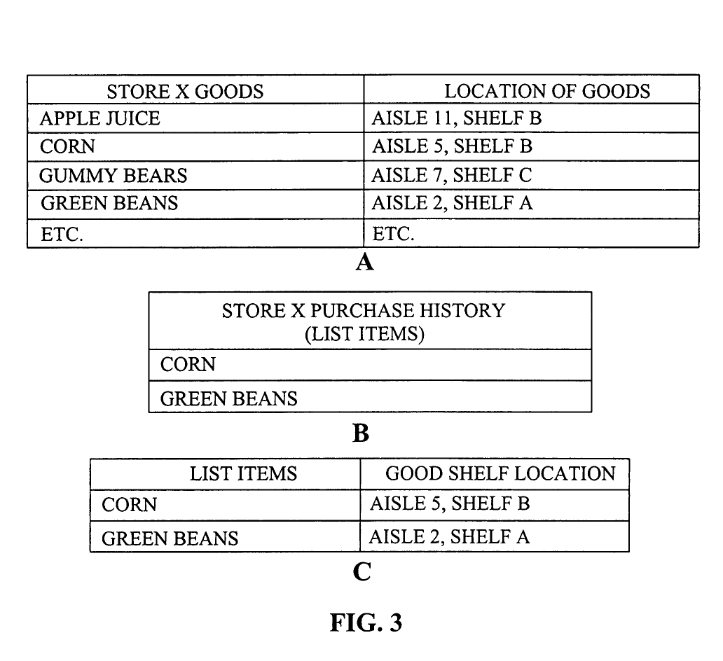

Now referring to FIG. 2, a block diagram is shown that illustrates a particular implementation of the method described above when used in a grocery store environment. In this implementation, item location information is maintained in a grocery item data file 210. Grocery item data file 210 includes information regarding the aisle and shelf location of groceries within the grocery store. An example of this item location information is shown in FIG. 3A. List items, i.e., those items that an individual has previously purchased at the grocery store, is maintained in individual purchase data history file 220. An example of list items is shown in FIG. 3B. Grocery data file 210 and list item file 220 are merged at 230, and a personalized shopping selection list is generated at 240. An example of the personalized shopping selection list is shown in FIG. 3C. The shopping list contains those items that were previously purchased at the grocery store by the shopper (i.e., corn and green beans), and the location of the those items in the grocery store (i.e., aisle 5, shelf B, and aisle 2, shelf A, respectively).

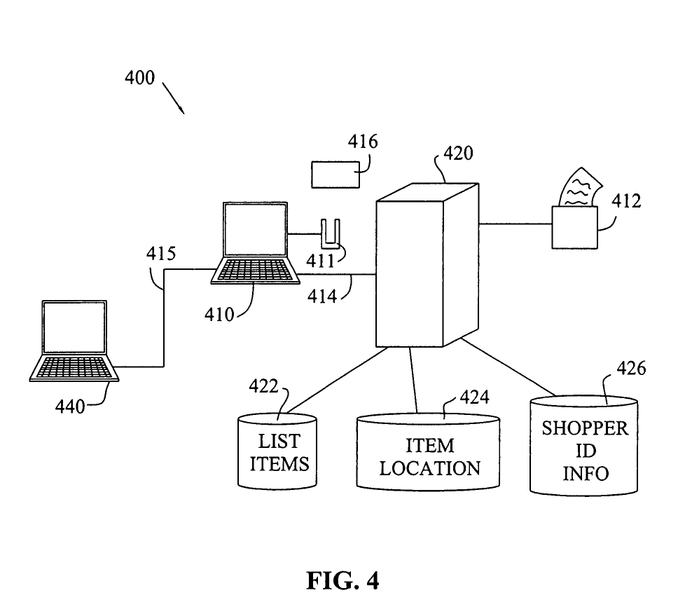

Shown in FIG. 4 is a network in which the present invention may be implemented. Network 400 includes cash register system 410 of a typical design for use in a retail store. Cash register system 410 may be a terminal or a personal computer in communication with server 420 over network 414. Network 414 may include a LAN.

Cash register system 410 includes card reader 411, e.g., a bar code reader, magnetic-stripe reader, smart card-contact reader, smart card-contact less (radio-frequency identification—RFID) reader or an optical reader. Card reader 411 is used to read personal user device 416. In an exemplary embodiment of the present invention, user device 416 is a loyalty card capable of using one of a bar code, magnetic-stripe, smart card-contact, RFID or optical machine-readable technology. Card 416 contains information that distinguishes one shopper from another. For example, card 416 may indicate that the shopper is shopper number XYZ, and this information is stored by the retail store in memory 426 of server 420. Accordingly, because shopper number XYZ can be identified, this identifying information can be crossed referenced with the shopper's list item information in memory 422 of server 420.

As described above, cash register system 410 is connected over network 414 to server 420. In an exemplary embodiment of the present invention, the method of the present invention may be implemented in computer software stored on server 420 and executed on a processor also therein. Server 420 includes memory 422 (e.g., a database), which maintains purchase history data for the retail store's shoppers, memory 424, which maintains the item location information for a retail store's consumer products, and memory 426, which maintains the retail store's shoppers' identification information. Both the item location and the shoppers' identification information may also be stored on memory within cash register system 410. The software provides computer instructions that instruct server 420 to access shopper identification information in memory 426 when a shopper's card 416 is read by device reader 411, cross reference the shopper's identification information with the shopper's list item information in memory 422, combine the shopper's list item information with the retail store's item location information, generate a personalized shopping list for the shopper based on the list item information and the retail store's item location information, and transfer the shopping list to the shopper. A shopper's list item information may also be stored in memory of computer 440 as well, in which case the shopper may send this information to server 420 over networks 414, 415 so that the shopper's shopping list can be generated.

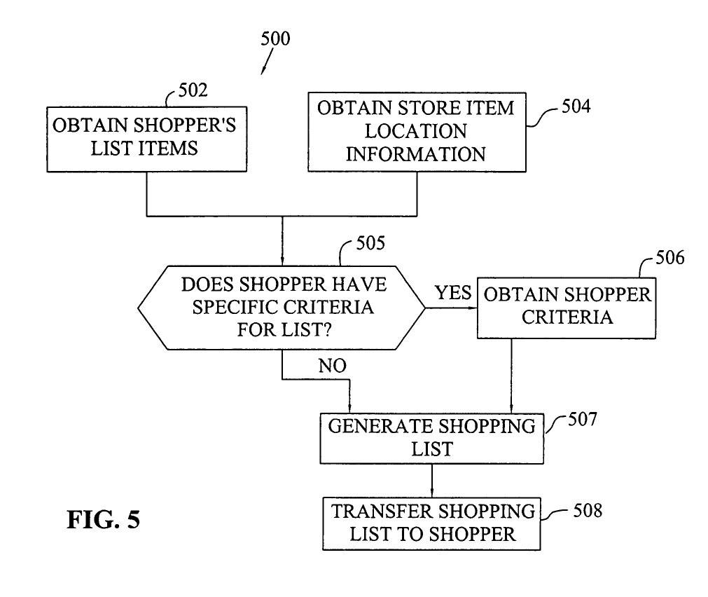

As illustrated in FIG. 5, the shopping list may be generated according to shopper-specified criteria such that it includes those items most recently purchased by the shopper or those items most frequently purchased by the shopper. The shopping list may also be generated to list the items in the order in which they are located in the store. For example, after the list item information and the item location information are obtained at steps 502 and 504, respectively, shopper criteria information may be requested at step 505. If the shopper does not have specific criteria according to which the shopper would like the shopping list to be tailored, the list is generated at step 507. If the shopper has specific criteria, this criteria information is obtained at step 506. The shopper, for example, may want their shopping list to be ordered based on the location within the retail store of the items on the shopping list. The shopper criteria information may be obtained by ascertaining a shopper's requested criteria through verbal communication or by accessing either a hard or an electronic copy of the criteria and then inputting the shopper's criteria into cash register system 410 (FIG. 4). The shopping list is then generated at step 507. Referring back to the earlier example in FIG. 3C, because green beans are located in aisle 2 and corn is located in aisle 5, in accordance with the shopper's request that their list be ordered according to consumer good location within the retail store, the green beans would appear before the corn on the shopper's personalized shopping list.

The personalized shopping list may be transferred to the shopper in multiple ways. Printer 412 may be used by the retail store to print out a shopper's personalized shopping list during the shopper's visit to the retail store. The personalized shopping list may also be mailed to the shopper or transmitted electronically via e-mail over Internet 415 to the shopper's personal computer 440. No matter the case, use of the method and system of the present invention provides more convenience to and enhances the shopping experience of the shopper.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A method of creating a shopping list, said method comprising the steps of:
obtaining a shopper's list items;
obtaining item location information; and
using the list items and the item locating information to create a shopping list containing the list items and the location within the retail store of store items one of the same as and similar to the list items.

2. The method of claim 1 further including a step of storing the list items in memory.

3. The method of claim 2 further including a step of storing the item location information in memory.

4. The method of 3 wherein the using step includes the steps of:
accessing the list items and the item location information;
cross-referencing the list items and the item location information; and
combining the list items and the item location information.

5. The method of claim 4 wherein the step of using further includes a step of arranging the list items on the shopping list according to how the store items are arranged in the retail store.

6. The method of claim 2 further including a step of storing memory reference data on a user device, the memory reference data corresponding to the list items.

7. The method of claim 6 wherein the step of accessing the user's list items includes a step of using a user device reader to access the list items.

8. A system comprising:
a processor; and
a software module containing instructions executable by said processor to create a shopping list, the shopping list including both list items and the location within the retail store of store products one of the same as and similar to the list items.

9. The system of claim 8 further comprising at least one memory coupled to said processor, said at least one memory containing user data that includes the list items.

10. The system of claim 9 wherein the at least one memory contains store product data that includes the location of store products within the retail store.

11. The system of claim 9 wherein the at least one memory contains said software module.

12. The system of claim 9 further comprising a user device that corresponds to the user data.

13. The system of claim 11 further comprising a user device reader coupled to the system for reading said user device.

14. A machine-readable program storage device for encoding instructions for a method of creating a shopping list, the method comprising the steps of:
obtaining a shopper's list items;
obtaining item location information; and
creating a shopping list including the list items and the location within the retail store of store items one of the same as and similar to the list items.

15. The machine-readable program storage device of claim 14 wherein the method of creating a shopping list further includes a step of storing the item location information in memory.

16. The machine-readable program storage device of claim 15 wherein the method of creating a shopping list further includes a step of accessing the list items and the item location information.

17. The machine-readable program storage device of claim 16 wherein the method of creating a shopping list further includes a step of combining the list items and the item location information.

18. The machine-readable program storage device of claim 14 wherein the method of creating a shopping list further includes a step of arranging the list items on the shopping list according to how the store items are arranged in the retail store.

19. The machine-readable program storage device of claim 14 wherein the method of creating a shopping list further includes a step of storing memory reference data on a user device, the memory reference data corresponding to the list items.

20. The machine-readable program storage device of claim 19 wherein the method of creating a shopping list further includes a step of using a user device reader to access the list items.
